(19) United States
(12) Patent Application Publication
(10) Pub. No.: US 2010/0236180 A1
(43) Pub. Date: Sep. 23, 2010

(54) METHOD FOR INSTALLING A SURFACE COVERING, AND APPARATUS THEREFOR

(75) Inventors: Joseph Rocco Pacione, Newmarket (CA); John Anthony Pacione, Newmarket (CA); Franz Rittmannsberger, Richmond Hill (CA)

Correspondence Address: OGILVY RENAULT LLP, 1, Place Ville Marie, SUITE 2500, MONTREAL, QC, H3B 1R1, CA

(73) Assignee: TAC-FAST GEORGIA LLC, ATLANTA (GE)

(21) Appl. No.: 12/733,019

(22) PCT Filed: Aug. 3, 2007
(86) PCT No.: PCT/CA2007/001374

§ 371 Date: May 24, 2010

(51) Int. Cl. E04B 5/00; B23P 11/00; B31B 1/00

(52) U.S. Cl. 52/578; 29/428; 493/393

(57) ABSTRACT

A method for installing a first surface covering element onto a surface is provided. The element has one half of a hook and loop attachment system, and the surface has the other of the hook and loop attachment system. The method may include the steps of: (i) placing the first element onto the surface so that at least some of the respective hooks and loops of the first element and surface engage; and (ii) applying a force to the first element to encourage tensioning in the loops; and (iii) securing the first element into place.

### FIELD OF THE INVENTION

The invention relates to a method for installing a surface covering and apparatus for facilitating the method.

### BACKGROUND OF THE INVENTION

Surface coverings such as tile, laminates, vinyl, ceramics, wood, carpet and other textiles, may be installed by attaching the coverings to the surface being covered. Installation is primarily concerned with attachment of the element to the surface. Gaps between elements may occur, facilitating entry of unwanted matter such as dust or liquids. Larger gaps may be unsightly.

### SUMMARY OF THE INVENTION

In accordance with a broad aspect of the present invention there is provided a method for installing a first surface covering element and a second surface covering element onto a surface, each of the elements having one half of a hook and loop attachment system, and the surface having the other of the hook and loop attachment system, the method comprising:

(i) placing the first element onto the surface so that at least some of the respective hooks and loops of the first element and surface engage;

(ii) placing the second element to marginally overlap the first element by a generally uniform amount, so that at least some of the respective hooks and loops of the second element and surface engage; and

(iii) applying a force to the second element, adjacent the overlap, to encourage the second element to move and to become generally coplanar with the first element and to eliminate the overlap.

The method may further comprise in step (ii), placing the second element with an amount of overlap that causes the loops to bias the second element against the first element after step (iii).

In another aspect, the amount of overlap is selected to cause the second element to be biased against the first element to create a seal between the first and second elements that is resistant to liquid transfer.

In another aspect, the amount of overlap in step (ii) is determined by a measurement of the maximum extension of the possible movement between the second element and the surface when at least some of the respective hooks and loops of the second element and surface engage, and the overlap is less than or equal to such maximum extension.

In another aspect, the amount of overlap in step (ii) is a function of the maximum resiliency of the loops.

In another aspect, the amount of overlap in step (ii) is a function of the maximum length of the loops.

In another aspect, the surface is a subfloor, and the method further comprises, before step (i), the step of placing the subfloor onto a floor, without attaching the subfloor to the floor.

In another aspect, the force is applied by hand.

In another aspect, the force is applied by a blunt instrument.

In another aspect, the force is applied progressively from one area of overlap to another area of overlap.

In another aspect, in step (ii) the second element is placed in a staggered relationship relative to the first element.

In another aspect, the method further comprising the step of:

(iv) placing a third element to marginally overlap both the first and second elements along adjacent edges by generally uniform amounts, so that at least some of the respective hooks and loops of the third element and surface engage; and

(v) applying a force to the third element, adjacent the overlap, to encourage the third element to move and to become coplanar with the first and second elements and to eliminate the overlaps.

In another aspect, the method further comprising the step of:

(iv) repeating all previous steps for a third element in conjunction with at least one of the first and second elements.

In another aspect, the first element is rigid.

In another aspect, the first element is made of one of vinyl, wood, linoleum, plastic, ceramic and rigid backed carpet.

In another aspect, the method further comprising, after step (i), positioning a template relative to the first element to cause the second element to overlap the first element by a predetermined amount; and, after step (ii), removing the template.

In another aspect, the first element also moves to tension the loops.

In another embodiment there is provided a decorative floor covering installation comprising:

a first surface covering element;

a second floor covering element;

a surface for receiving the first and second elements, each of the elements having one half of a hook and loop attachment system, and the surface having the other of the hook and loop attachment system, the first and second elements being attached to the surface by the hooks and loops, and the first and second elements being biased against one another.

In another aspect, at least some loops are approaching maximum extension and movement of at least one of the elements away from the other is limited.

In another aspect, at least some loops are approaching maximum extension so that the first element is biased against the second element to form a liquid resistant seal.

In another aspect, the surface is a free floating subfloor.

In another aspect, wherein the first element is rigid.

In another aspect, wherein at least some loops are extended by a predetermined amount.

In another aspect, the predetermined amount is at least twenty-five percent of a maximum extension of the loops.

In another aspect, the first element is flexible and resists folding.

In another aspect, the first element is made of one of vinyl, wood, linoleum, plastic, ceramic and rigid backed carpet

In a further embodiment there is provided a method for making a floor covering module having a covering element with at least one side substantially covered in one of hooks and loops of a hook and loop attachment system, and a sheet substantially covered the other of hooks and loops, the method comprising the steps of:

(i) bending the sheet;

(ii) placing the covering element onto the sheet to permit at least some of the hooks to engage at least some of the loops; and

(iii) flattening the combined sheet and covering element for placement onto a surface.

In another aspect, the sheet is bent to present a convex surface for attachment to the covering element.

In another aspect, the sheet is bent to present a generally helical surface for attachment of the covering element.

In another aspect, the covering element is placed onto the sheet to overlap along at least one edge.

In a further alternative embodiment there is provided a planar surface comprising a subfloor substantially covered with loops and at least two decorative covering elements having complementary loops for attachment to hooks, in which at least some of the loops of at least one of the decorative covering elements are in tension pulling that element in to abutment with the other element.

In a yet further embodiment there is provided a method for installing a first surface covering element onto a surface, wherein the element has one half of a hook and loop attachment system, and the surface has the other of the hook and loop attachment system, the method comprising the steps of: (i) placing the first element onto the surface so that at least some of the respective hooks and loops of the first element and surface engage; (ii) applying a force to the first element in a direction generally parallel to the surface, to encourage tensioning in the loops; and (iii) securing the first element into place.

Other and further advantages and features of the invention will be apparent to those skilled in the art from the following detailed description of embodiments thereof, taken in conjunction with the accompanying drawings.

### BRIEF DESCRIPTION OF THE FIGURES

The present invention will be further understood from the following detailed description of embodiments of the invention, with reference to the drawings in which:

FIG. 1 illustrates in isometric view, a partially installed decorative covering over a field of hooks;

FIG. 2 is a side view of decorative elements installed onto a field of hooks;

FIG. 3 shows an alternative hook sheet for providing a field of hooks;

FIG. 4 is a partial side view of a decorative element and corresponding hooked surface prior to attachment;

FIG. 5 illustrates the decorative element and hooked surface of FIG. 4 engaged;

FIG. 6 is an isometric view of FIG. 5;

FIG. 7 illustrates a decorative element overlapping an adjacent decorative element prior to installation;

FIG. 7a illustrates a loop in various degrees of extension;

FIG. 7b is a top view of FIG. 7;

FIG. 8 illustrates the decorative element of FIG. 7 installed;

FIG. 9 is an isometric view of a template;

FIG. 10 is an isometric view of an alternative embodiment of a template;

FIG. 11 is a side view of the template of FIG. 9 in use;

FIG. 12 illustrates installation of a decorative element using an alternative template;

FIG. 12a illustrates the installation of decorative elements having a complimentary tongue and groove;

FIG. 13 illustrates a method of installing decorative elements using the template of FIG. 9;

FIG. 14 illustrates the installation of decorative elements in addition to those of FIG. 13;

FIG. 15 illustrates the installation of decorative elements employing the template of FIG. 10;

FIG. 16 illustrates the installation of decorative elements in addition to those illustrated in FIG. 15;

FIG. 17 illustrates the installation of decorative elements employing both the template of FIG. 9 and the template of FIG. 10;

FIG. 18 illustrates the installation of different developments having an irregular configuration;

FIG. 19 illustrates a bendable hook sheet;

FIG. 20 illustrates a bendable decorative element;

FIG. 21 illustrates the attachment of the hook sheet of FIG. 19 and the decorative element of FIG. 20;

FIG. 22 illustrates the module of FIG. 21 unbended;

FIG. 23 illustrates an installation of multiple modules of FIG. 22;

FIG. 24 illustrates a blunt instrument; and

FIG. 25 illustrates a spreader assembly.

### DETAILED DESCRIPTION OF THE INVENTION

Similar references are used in different figures to denote similar components. Proportions and positioning of illustrated elements may be exaggerated or distorted in order to better illustrate the methods and apparatus.

Releasable attachment systems have been used to conveniently install decorative floor coverings. In particular, complimentary hook and loop attachment systems, such as those disclosed and in prior patents (and applications) including U.S. Pat. Nos. 6,306,477; 6,298,624; 6,802,167; 7,096,632; and application Ser. Nos. 10/013,688; 10/543,905; 10/543,904; 10/543,902; 10/543,906; 10/879,149; 10/543,901; and 10/543,903, all of which are herein incorporated by reference.

In general, a field of hooks (or loops) may be provided on a surface to be covered. A decorative covering may be provided having a side covered with loops (or hooks, as the case may be) for engaging the complimentary hooks (or loops) of the surface. This arrangement has the advantage that the decorative coverings may be easily repositioned during installation, and after installation, one or more decorative coverings may be removed and replaced to address wear and tear, or to change the appearance of the surface that is covered. The present disclosure provides methods and tools for encouraging the installed decorative coverings to fit more closely with one another. This is achieved by biasing or tensioning the hook and loop attachment as described herein. This may reduce the occurrence of unsightly gaps between the decorative coverings, and, to the extent that adjacent decorative coverings abut one another, such installation may also inhibit the passage of foreign elements such as dust, and possibly liquids, between the decorative coverings.

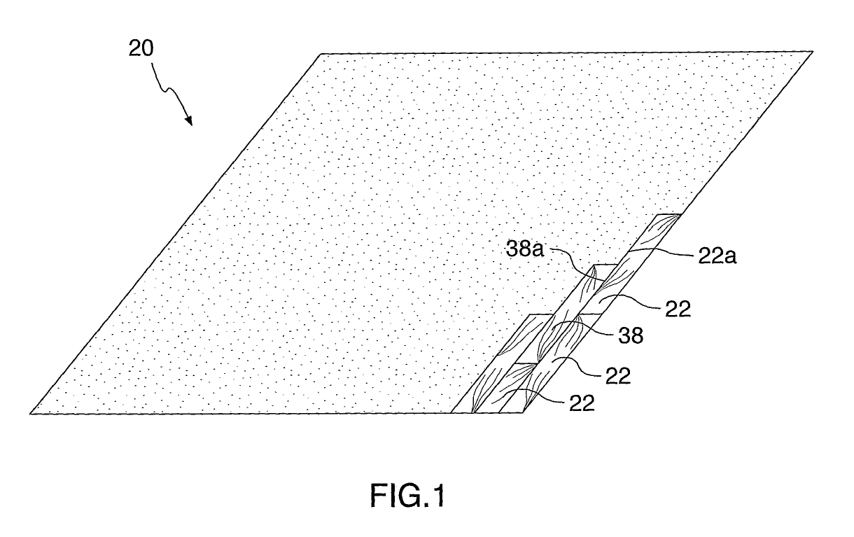

FIG. 1 illustrates a field of hooks 20 for receiving a decorative covering. The field of hooks may be provided by an installed anchor sheet sub-floor (as disclosed in the patents and applications listed above) or by attaching a hook tape to a surface or in some other known manner. Field of hooks 20 may be free floating (if installed on a floor, for example), or it might be glued, screwed, nailed, or otherwise attached to the surface (particularly if used on non-horizontal surfaces such as walls and ceilings).

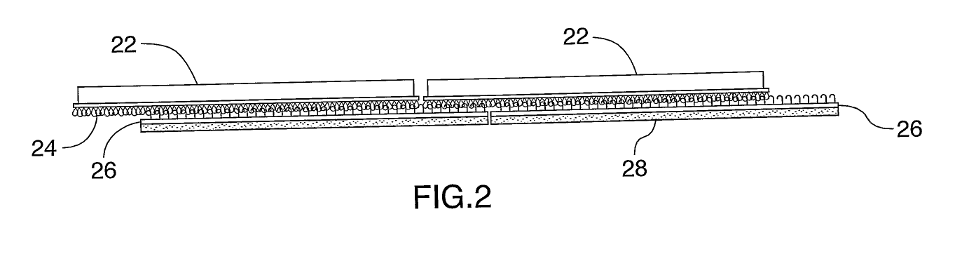

Surface covering elements 22, such as vinyl planks, may be provided with loops 24 (as illustrated in FIG. 2) for engagement with the hooks of the field of hooks 20. Any other decorative covering may be used, such as decorative coverings made of vinyl (including luxury vinyl tile), wood (including wood products, laminates and composites), linoleum, plastic, ceramic, and generally rigid textiles, such as rigid backed carpet. Preferably, the decorative coverings used resist folding. Any combination of these coverings may also be used. It is preferred that the decorative covering used has a degree of rigidity that inhibits it from significantly deforming when a lateral force is applied to it and the loops (or hooks) of the decorative covering are at least partially engaged. It should be noted that the decorative covering may instead be provided with hooks, and loops may be provided to cover the surface.

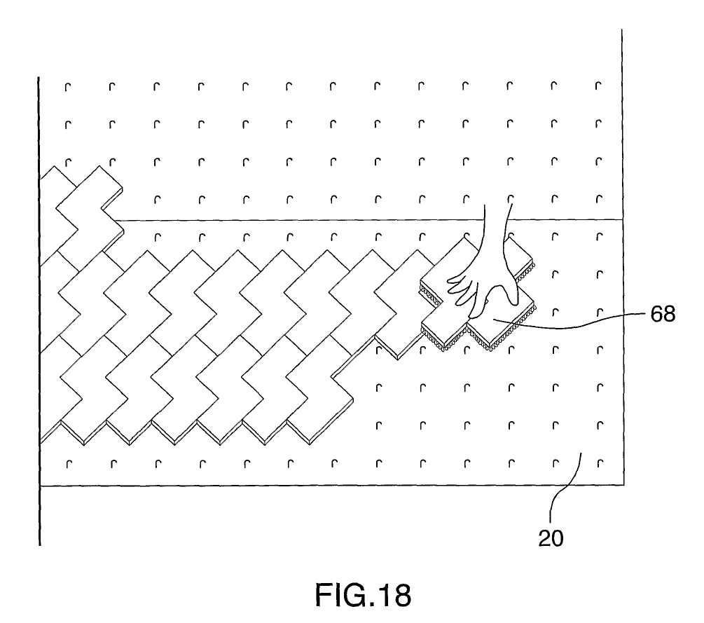

Decorative elements may also have different or complimentary geometric shapes. The shapes may also be irregular or non-uniform so long as adjacent decorative elements may be installed according to the method described herein. An example of irregular decorative elements is illustrated in FIG. 18, irregular patterns of two or more decorative elements each having different but complimentary shapes may also be employed either in a pattern, or in a unique arrangement.

FIG. 2 illustrates an embodiment having one or more hooked sheets 26 that are used to provide a field of hooks for attachment of planks 22. Hooked sheets 26 may optionally be provided with a resilient layer or a cushion 28 to improve the comfort of the decorative covering when used or walked upon. As noted, many of the figures have their dimensions exaggerated in order to illustrate the new method, installation and tools. Typically, the loops 24 will extend approximately.

For example, a typical hook sheet might be between a sixteenth of an inch and three quarters of an inch thick, and a typical decorative element may have similar dimensions. However, thinner and thicker decorative elements and hook sheets may be employed. When a hook sheet with integral stems is used, the stems may be one millimeter high and 0.55 millimeter in diameter. The hooks (and sheet) may be made of polypropylene. The ratio of stem height to diameter is preferably about 2:1, and may be as great as 10:1. The stem diameter may be in the general range of 0.3 to about 0.9 millimeters. Stem diameters of as small as 0.1 millimeter may be acceptable.

Decorative elements, such as luxury vinyl tile that are typically used without hook and loop attachment may be converted simply by adding hooks and loops, as appropriate. Alternatively, decorative covering elements may be specifically manufactured to take advantage of the hook and loop attachment systems. For instance, such decorative coverings may be manufactured to have less rigidity because the hook surface or hook sheets will also contribute to the overall rigidity of the floor covering.

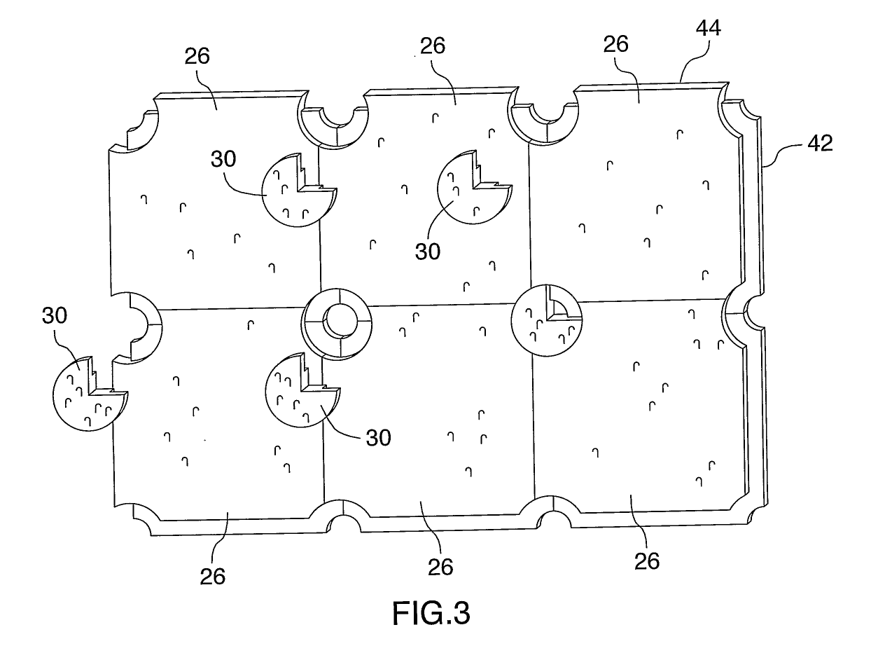

FIG. 3 illustrates a field of hooks provided by hook sheets 26 (which may include hooked attachment devices 30) as disclosed in U.S. Pat. No. 7,096,632.

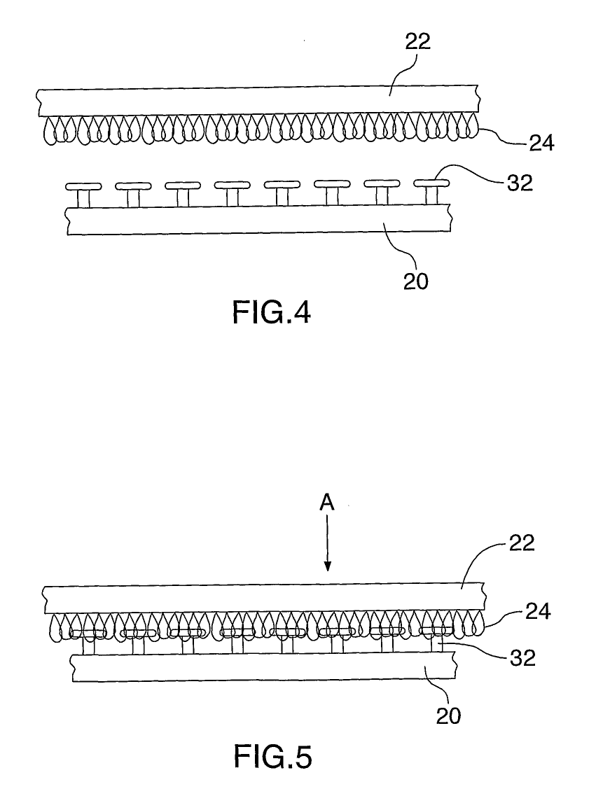

FIG. 4 shows a decorative covering 22 prior to installation onto a field of hooks 20. Field of hooks 20 is illustrated having integral hooks 32. Hooks 32 may be “mushroom-shaped”. Non-integral hooks, such as included with hook tape, and non-mushroom-shaped hooks, may be used. In fact, any element that conveniently engages a loop surface (or velvet-type fastener) may be employed.

FIG. 5 shows the decorative covering element 22 having at least some of loops 24 in engagement with hooks 32. As decorative element 22 is moved towards hook sheet 26 in a generally lateral direction “A”, one or more loops 24 engage or “lasso” one or more hooks 32. In this arrangement there may be play between decorative element 22 and field of hooks 20 in a direction generally perpendicular to direction “A”. There is generally little or no play if removal of decorative element 22 is attempted in a direction generally opposite to direction “A”, because some loops 24 are now engaged with hooks 32. However, decorative element 22 may conveniently be removed from field of hooks 20 by prying or bending an edge of the element and peeling it away from the field of hooks 20. In this manner one or more decorative elements 22 may be repaired and/or replaced. This first decorative element 22 is preferably installed so that loops 24 have minimal or no tension in a direction generally perpendicular to “A” (though it may have such tension).

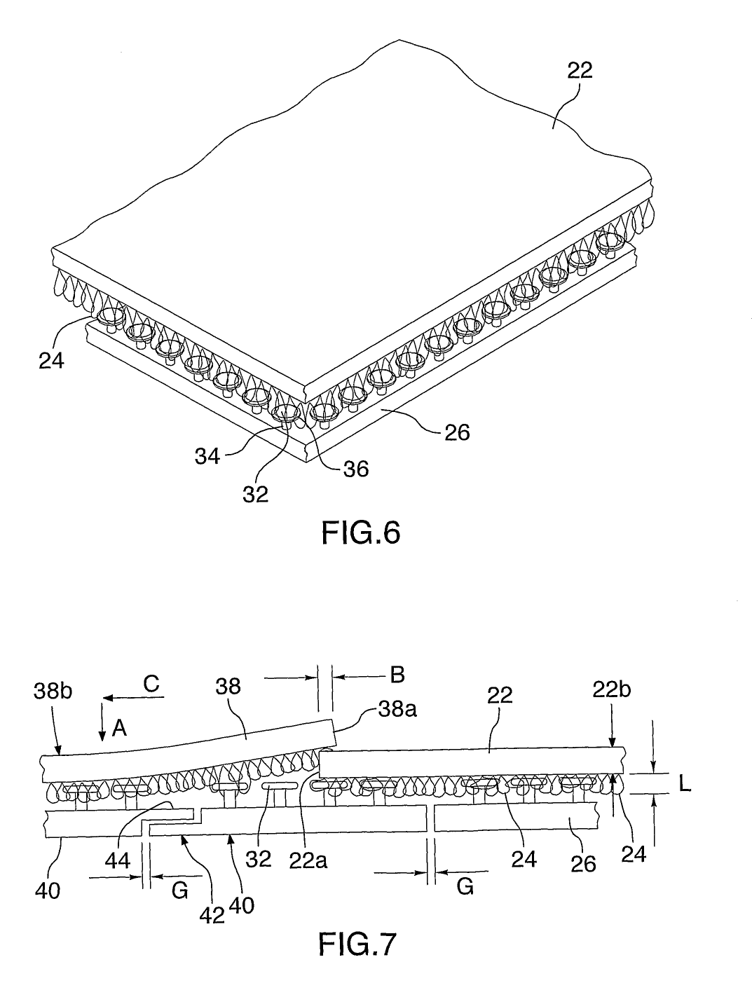

FIG. 6 illustrates a plank 22 attached to a hook sheet 26 in the manner of FIG. 5. Plank 22 may move in a plane generally parallel to hooked sheet 26 due to at least one of: (a) play in the length of loops 24 and resiliency in loops 24. Depending on the material used for hooks 32, there may be additional play in the hooks themselves. Similarly, the geometry of the stem 34 and head 36 of hook 32 may also contribute to the degree of play of plank 22 (or other decorative elements) relative to hooked sheets 26. Such play may be undesirable, particularly when decorative elements having clearly defined edges are used. For example, when multiple planks 22 (as seen for example in FIG. 1) are laid onto the field of hooks 20, any gaps between planks 22 may be noticeable due to the regular geometric edges of each plank 22. Furthermore, even a minimal degree of play provided by loops 24 (and to a lesser extent, if at all, hooks 32) may permit undesirable foreign matter to enter any such gap.

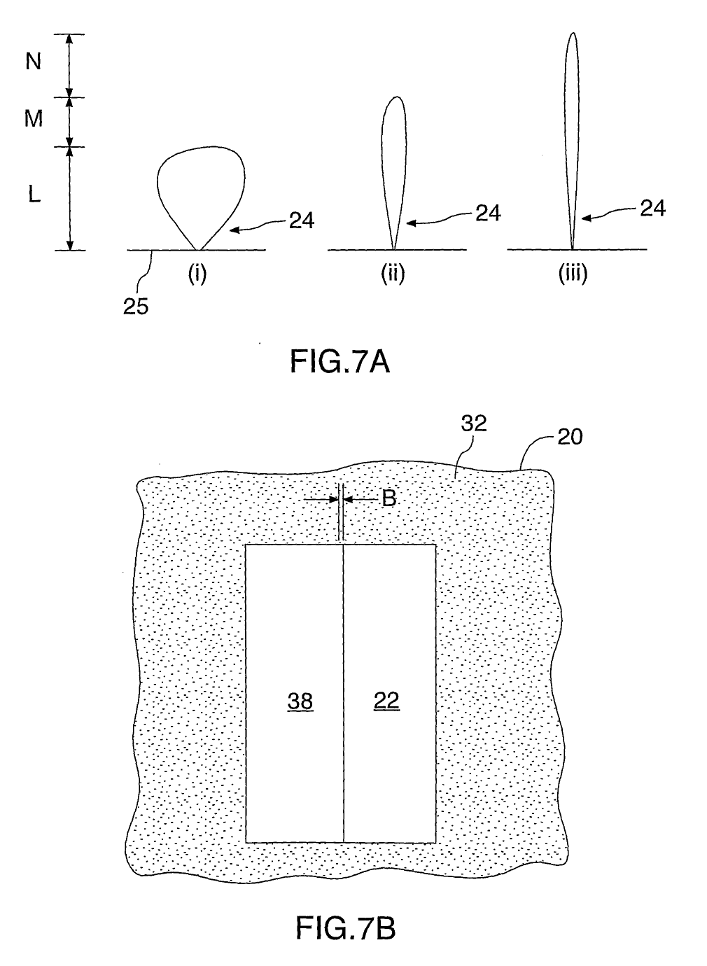

FIG. 7 illustrates another step in the installation of decorative elements onto a field of hooks. Once a decorative element 22 has been installed onto one or more hooked sheets 26 (decorative element 22 is illustrated in FIG. 7 as being attached to at least 2 hooked sheets 26), a second complimentary decorative element 38 may be installed.

Decorative element 38 may be identical to decorative element 22, but it need not be. For example, decorative element 22 may be a wooden or vinyl floor plank, whereas decorative element 38 may be made of ceramic or some other material. It is preferable that corresponding edges 22a and 38a of decorative elements 22 and 38 are generally congruent to one another (as shown in FIGS. 1 and 7). The relative thicknesses 22b and 38b of the decorative elements may be the same, or they may be different, depending upon the intended use or visual effect desired.

Decorative element 38 may be placed upon one or more anchor sheets 26 so that at least some loops of decorative element 38 are caught or retained by one or more hooks 32. Unlike the installation of decorative element 22, decorative element 38 is installed so that it overlaps decorative element 22, preferably along an edge thereof. The amount of overlap “B” is preferably similar to a length “L” of a loop 24.

FIG. 7a presents an isolated view of a loop 24. FIG. 7a(i) shows loop 24 unextended. FIG. 7a(ii) illustrates that loop 24 may be extended by distance “M”, for example, when loop 24 engages a hook (not shown) and at least one of the loop 24 and the hook is moved. Any resiliency in loop 24 to return to its original shape of FIG. 7a(i) will cause a force to be exerted upon the hook. If the loop is not resilient, then the loop, when extended as shown in FIG. 7a(ii), will inhibit further movement of an attached hook. FIG. 7a(iii) illustrates a loop that can resiliently stretch by distance “N”. In this position, the loop may exert additional force on an attached hook. In all of the sub-figures of FIG. 7a, loop 24 is shown extended generally perpendicularly to substrate 25. In practice, loop 24 will typically be extended at an angle relative to substrate 25 as an attached decorative element 38 is moved as it is installed.

Overlap “B” may be calculated based upon the length and resilience of loop 24 and the desired force of abutment between decorative elements 38 and 22. For example, overlap “B” may be similar to distance “L”, particularly if many loops 24 are compressed or bent adjacent to the substrate 25 to which loop 24 is attached. An overlap “B” in the range of L+M, or L+M+N may also be selected, depending upon the resiliency of loops 24 and the requirements of the installation (e.g., closely abutting decorative elements).

Accordingly, to the extent that loops 24 (or hooks 32) also have elasticity or resiliency, the overlap “B” may be greater. In an embodiment, overlap “B” may be between about one millimetre and thirty millimetres and might also be in the range of two millimetres to ten millimeters. An overlap “B” of about 2 to 3 millimetres has been found to be effective. In the present example, overlap “B” is about 2 millimetres.

The amount of overlap “B” may be determined by a measurement of the maximum extension of the possible movement between the decorative element 38 and field of hooks 20, when at least some of the respective hooks 32 and loops 24 of decorative element 38 and field of hooks 20 engage. For example, this may be done by placing (in direction “A”) decorative element 38 upon a field of hooks 20 and then applying a force, for example, in direction “C”. The maximum relative displacement of decorative element 38 may be used as overlap “B”. Overlap “B” is preferably less than or equal to such maximum extent of movement.

For example, in an embodiment, decorative element 38 can move by two millimeters when at least partially attached and generally parallel to field of hooks 20. Accordingly, overlap “B” is preferably about two millimeters or less. The closer that overlap “B” is to the maximum relative movement, the greater the likelihood that decorative element 38 will exert force against decorative element 22 once installed. If loops 24 are not resilient, overlap “B” will typically be less and a force exerted by decorative element 38 upon decorative element 22 may be less. In this example, loops are manufactured by stitching polyester yarn (to form the loops) through a polypropylene layer using a malimo process. Such loops are manufactured by Scott & Fyfe in Scotland under part number 40/film. Suitable loops made by other manufactures and with other materials may also be suitable. For example, fleece or “fluffy” materials may be suitable. The hooks are mushroom shaped and may have the following approximate dimensions: 0.5 mm diameter; 0.6 mm length; and 0.9 mm head.

Even if a force is not exerted, an overlap “B” may be used to at least reduce the amount of play in decorative element 38 relative to field of hooks 20.

To install decorative element 38, a force is applied to decorative 38. Force is applied in the region of the overlap to (i) cause decorative element 38 to become generally co-planer with decorative element 22, and (ii) to enable at least one loop 24 that is free to engage a hook 32. For decorative elements 38 made of more rigid materials, the force applied may be in the general direction “C”. The force is applied in general direction “C” until overlap “B” is reduced or eliminated. A force may then be applied in the general direction “A”. It must be emphasized that the particular direction that decorative element 38 is moved need not be precise, as long as the overlap area “B” is eliminated, and decorative element 38 is permitted to become somewhat co-planer with decorative element 32.

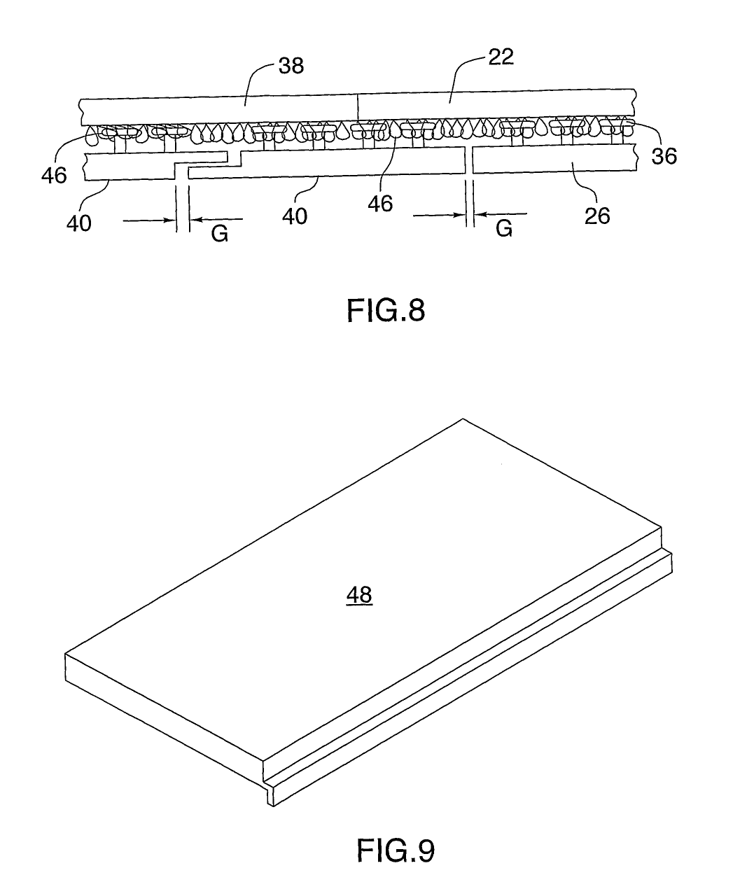

For less rigid decorative elements, a force in a combined direction A+C may be applied, where the particular force component A or C may be different, or varied. When relatively resilient luxury vinyl tile is used for decorative element 38, a quick blunt force applied in the general direction “A” to the overlap area “B” can serve to quickly place decorative element 38 into the desired alignment (as shown in FIG. 8). This may work with other materials as well.

The amount of force and the manner in which it is applied may vary depending on the material used for decorative element 38. For example, if a resilient material is used, then a blunt instrument such as a hammer or a rigid brick-like structure, or some other suitable element, may be used without damaging the decorative coverings 38 and 22. Padding may be applied to any tool (or hand) used to apply the force in order to reduce damage to the decorative element. Similarly, protective padding may be applied onto any area of a decorative covering that receives a force. For some installations, it may be possible to simply apply the force to decorative element 38 by hand. However, this may not be as efficient as using a tool. On the other hand, for particularly brittle or delicate floor coverings 38, hands or tools gently applied may be required to protect the covering.

Any force applied to decorative covering 38 may ideally be applied along the entire overlap area at once. Alternatively, force may be applied at two or more regions of the overlap area, either simultaneously or sequentially. For example, force may be applied at one end of the overlap area (see FIG. 8) and progressing to another end of the overlap area to progressively cause decorative element 38 to align with decorative element 22. A roller could be used to progressively impart such a force along the interface between decorative element 38 and 22

As a force is applied to decorative element 38 to move it, loops 24 are caused to slide around respective hooks 32 and at least some of the loops become taut. Thus a tensioning or biasing force is created, encouraging the decorative element 38 to abut decorative element 22. This may reduce the extent of movement of decorative element 38 in general, and in particular, it may serve to reduce the extent of movement of decorative element 38 within the plane of decorative element 38. To the extent that loops 24 (or hooks 32) are resilient, applying additional force may stretch the loops 24 and/or hooks 32 to further inhibit movement of decorative element 38. This arrangement may also inhibit unintentional removal of the decorative elements 22 and 38.

If there is minimal or no resiliency in loops 24 (or hooks 32), then when decorative element 38 is brought into alignment with decorative element 22, the ability of decorative element 38 to move relative to field of hooks 20 may be reduced as compared to a decorative element installed in the manner of FIGS. 4, 5 and 6. In many embodiments, most, if not all, of the play that permits decorative element 38 to move relative to decorative element 22 in order to eliminate the overlap, is provided by loops 24.

If overlap “B” is made large relative to the length “L” of loops 24, or if it is made large relative to the resilient extent of loops 24, then additional energy may be stored in the loops 24 that initially engage hooks 32 when decorative element 38 is first placed upon field of hooks 20. This additional energy is stored when decorative element 38 is made co-planer with decorative element 22. As overlapped decorative element 38 is moved into place, loops 24 become taught around corresponding hooks 32. (If resilient loops are used then, loops 24 elastically stretch as additional force is applied to decorative element 38.) When decorative element 38 is aligned with decorative element 22, loops 24 that have been elongated and/or stretched, exert a force to encourage decorative element 38 towards decorative element 22 in a direction generally opposite to direction “C”. This may encourage decorative element 38 to abut decorative element 22. This abutment may reduce any unsightly gaps between decorative element 38 and 22. It may also reduce the ability for foreign and unwanted matter to pass between decorative elements 38 and 22. When sufficiently resilient loops 24 (and/or hooks 32) are used, the force exerted by decorative element 38 upon decorative element 22 may be sufficient to make the interface between the decorative elements resistant, or possibly even impermeable, to a liquid.

If decorative element 38 is not adequately aligned relative to decorative element 22, then a gap may still exist. It has been found that as additional decorative elements are added adjacent to the installed decorative elements, any gaps between previously installed decorative elements may be reduced or eliminated.

The described installation has the further advantage that, as the installed decorative elements (and other components) expand and contract due to environmental conditions, the play provided by the combined hook 32 and 24 arrangement, may accommodate some of such expansion and contraction, and may reduce the likelihood of the decorative elements to form gaps, or to cup or buckle.

Additional accommodation for excess stress within the components of the decorative covering and field of hooks may be obtained by use of hooked sheets 26 that are permitted to free float over, or have minimal attachment to, a surface such as a floor. For example, a gap “G” may be provided when hooked sheets 26 are laid upon a surface. Gap “G” may be as small as a fraction of a millimetre and may be as large as one centimetre or more, depending upon the nature of the surface element 22 and the intended use for the covering. In an embodiment, a gap “G” of about 2 millimetres may be used. Gap “G” may permit movement of one or more hook sheets 26 as decorative element 38 is being installed. For example, if overlap area “B” is too large, and there is not enough play and/or resiliency within hooks 32 or loops 24 to permit installation of decorative element 38, then hooked sheets 26 may move to reduce or close gap “G” to permit installation of decorative element 38. Similarly, expansion and contraction of the various elements described due to environmental or other factors may be accommodated by gaps “G”. This may serve to reduce cupping, bending, and other deformations in the surface made up of decorative elements such as decorative elements 22 and 38. Gaps “G” may affect the calculation of the preferred overlap “B”, because the gaps may permit additional movement of portions of hooked surface 20, particularly when a decorative element 38 spans a gap “G”.

Alternative hook sheets 40 may be employed to permit movement of hook sheets relative to one another. Such hook sheets may have overlapping expansion areas about portions 42 and 44. Hook sheets that include this configuration are illustrated in FIG. 3 (but the sheets illustrated in FIG. 3 have additional elements including attachment devices 30, that may not be necessary).

As noted above, the various components described, when installed, tend to be nearly flush with one another. Any gaps or spaces shown in the figures are exaggerated for illustration and ease of explanation. Similarly, the field of hooks 20 and hook sheets 26 forming a field of hooks 20 are sometimes illustrated in the figures with hooks missing in an area or with hooks missing about the edges or perimeter. This is done for ease of illustration or may be done for ease of manufacture. However, hooks may be included over the entire surface, or strategically placed upon select portions of a surface to be covered to enable decorative elements to be installed in a manner described herein.

FIG. 8 illustrates decorative element 38 installed according to the method above. Note that some loops 46 may be extended or stretched about a portion, or all, of hooks 36. Such stressing or tensioning of loops may cause decorative element 38 and 22 to become biased against one another. Nevertheless, one or more of decorative elements 22 and 38 may be removed, for example, by prying so that such element may be replaced or repaired. This may sometimes be done by hand, but may be conveniently done by inserting a narrow tool, such as a spatula or putty knife, between decorative element 38 and 22, and prying or peeling the desired decorative element away.

FIG. 8 also illustrates how gaps “G” may change in size after decorative element 38 is installed. For example, gap “G” between sheets 40 may be larger, and gap “G” between sheets 40 and 26 may become smaller.

In the foregoing embodiments an overlap has been used to permit the engagement and tensioning of connected hooks and loops to encourage decorative element 38 to be retained by surface 20, and to encourage abutment of decorative element 38 against decorative element 22. In another embodiment, a fixed feature (not shown) such as a piece of wood nailed or glued to a surface may be used instead of decorative element 22 (at least for the installation of a first decorative element 38, or row of decorative elements 38). In this embodiment, decorative element 38 is overlapped with the fixed feature, and installed as described above.

In a further alternative embodiment, decorative element 38 is placed upon surface 20 in general direction “A”. A force generally parallel to surface 20 may be applied to decorative element 38. This force may cause decorative element 38 to become displaced, and loops 24 (and possibly hooks 32) to be elongated or stretched in the manner described herein. Once decorative element 38 is displaced by a desired amount, it may be held generally in place by placing decorative element 24 in abutting relationship to it. Any resilience in loops 24 (or hooks 32) may cause marginal displacement of decorative element 24. In this embodiment, a similar abutting relationship is achieved to that described for when decorative covering 38 is installed by overlapping it. Decorative element 38 may alternatively be held in place, once moved, by something other than decorative element 22. In this embodiment, decorative element 38 may be moved by hand or by employing a tool having a slip resistant surface.

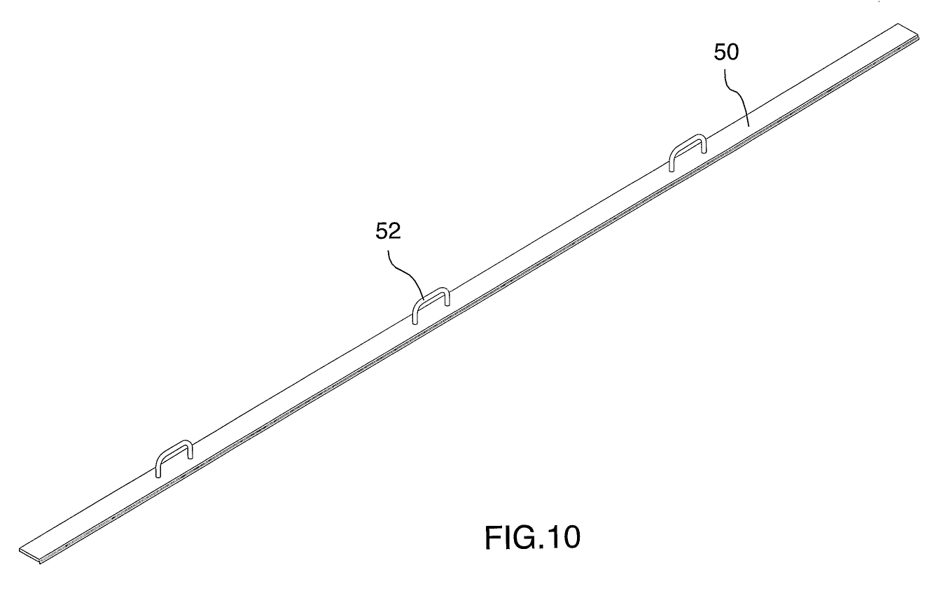

FIG. 9 illustrates a template that may be used to assist in facilitating alignment between decorative element 38 and 22 so that there is a preferred or predetermined overlap “B”. The various dimensions of template 48 may be varied as needed. For example, FIG. 10 illustrates an elongate template 50, which may have a similar cross section to template 48, but that has a greater length to accommodate different installation patterns (described later) or different sized decorative elements. Handles 52 may also be included.

Template 48 is illustrated having a straight edge. This is done so that it conforms to an edge such as edge 22a of a decorative element 22. If decorative element 22 has a curved edge, or an irregular edge, then template 48 may be configured accordingly.

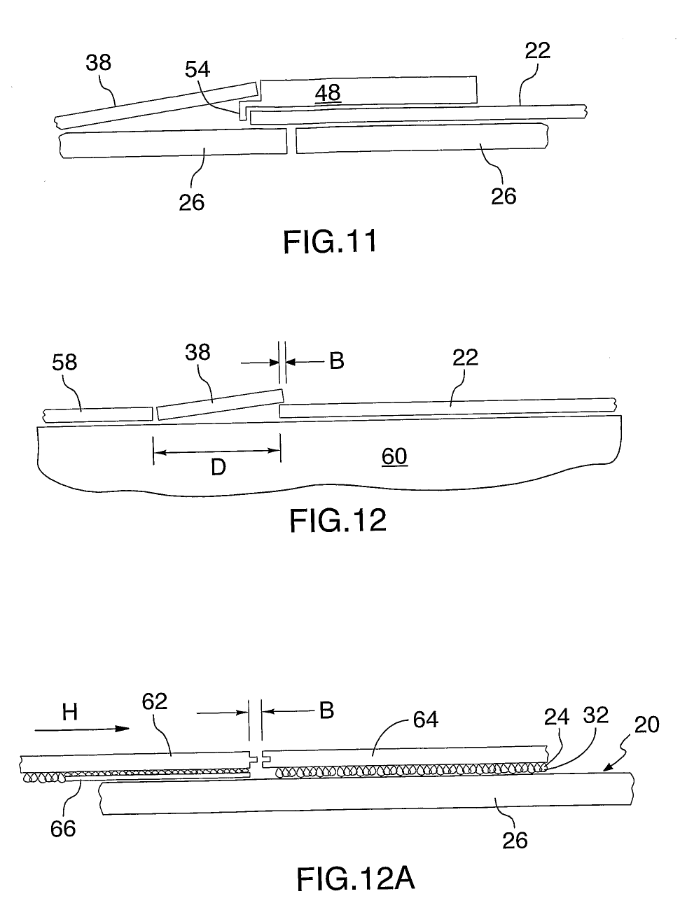

FIGS. 11, 12 and 12a illustrate the use of various templates and methods used to install decorative elements. For ease of illustration, these figures do not show the hook and loops in detail. As noted, the hook and loop arrangement may be reversed.

FIG. 11 illustrates use of template 48 to encourage proper placement of decorative element 38 relative to decorative element 22. A leg or other protrusions 54 provides a stop for template 48 to align it relative to decorative element 22. A rebate 56 is configured to provide a predetermined amount of overlap for decorative element 38 relative to decorative element 22. Once decorative element 38 is positioned, template 48 may be removed. Template 48 is preferably removed by sliding it along edge 22a. If it is not possible to slide template 48, then it may be carefully lifted while holding attached portions of decorative element 38 in place. Decorative element 38 may then be installed in a manner described above.

FIG. 12 illustrates an alternative template 58. Template 58 is held in place by hook and loop, or some other means, to the surface such as a floor 60. Template 58 is placed a distance “D” from decorative element 22 to position decorative element 38 so that it overlaps by amount “B” when it is abutted against template 58. Decorative element 38 may then be installed in the manner described above. Template 58 may also be provided with a standoff (not shown). The standoff may be in the nature of an arm for abutting against edge 22a of decorative element 22. The standoff may permit template 58 to be held in place manually, without the need for attachment to a surface such as floor 60.

In an alternative embodiment, a template congruent to but smaller than the decorative element 38 may be placed on the surface 20. Decorative elements 24 may then be placed adjacent the perimeter of the template. The template may then be removed to reveal an exposed area of surface 20 that is marginally smaller than decorative element 38. Decorative element 38 may then be placed within the exposed area with one or more edges overlapping a respective decorative element 24. Each overlap may then be removed employing the method described above.

FIG. 12a illustrates the installation of decorative elements 62 and 64 having cooperating tongues and grooves. Decorative element 64 having an exposed tongue or groove may be installed in the manner described above. Decorative element 62 having the other of a tongue and a groove may be installed using a sheet 66 that has at least one surface that does not engage hooks 32. Such surface is placed against hooks 32. A thickness of sheet 66 may correspond to a distance between decorative element 64 and field of hooks 20.

Decorative element 62 is installed by first placing sheet 66 upon field of hooks 20. Decorative element 62 may then be slid into position by applying a force in the general direction “H”. Sheet 66 is then removed. While this installation method may not provide significant biasing of decorative element 62 against decorative element 64, it enables the positioning of the tongue within the groove to inhibit passage of foreign matter, and to reduce the occurrence of gaps between decorative elements.

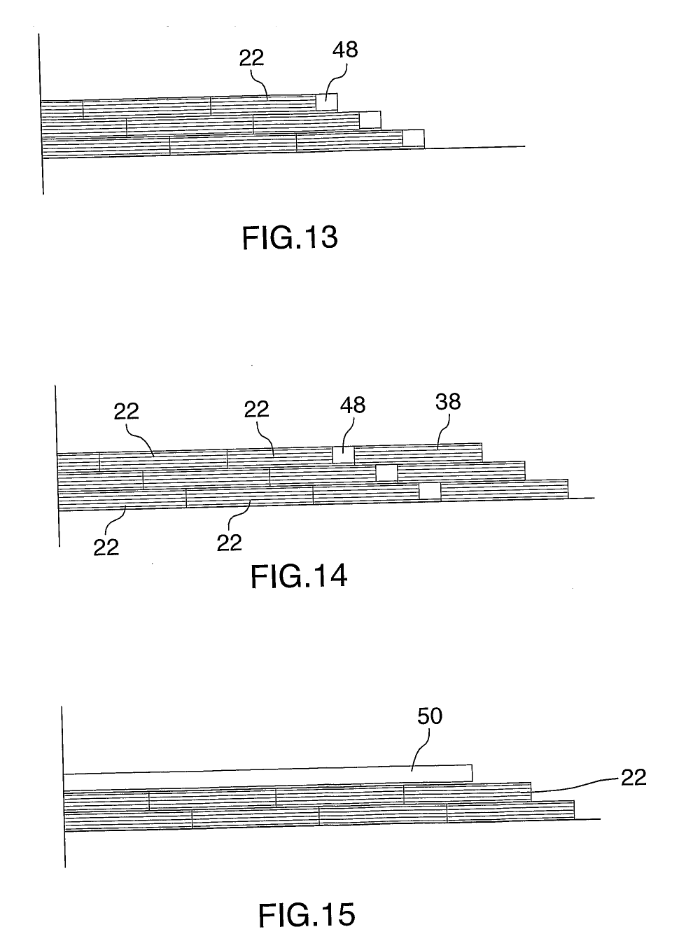

FIGS. 13 to 17 illustrate an example of how decorative elements such as planks 22 and 38 may be installed. It is emphasized that this is but an example and many other variations may be employed to install decorative elements according to the method described herein. Furthermore, the particular demands of the installation and the properties of the decorative elements and field of hooks may require different steps to be taken and a different orientation of elements.

FIG. 13 illustrates a number of decorative elements 22 placed upon a field of hooks 20. It is not necessary for such decorative elements to be installed in a manner described above. Such decorative elements may be placed upon the field of hooks, in a staggered relationship, without overlap. Subsequent installation of additional decorative elements may serve to exert a force on the installed decorative elements shown in FIG. 13 (alternatively, one large decorative element could be installed instead of multiple decorative elements 22). Once decorative elements 22 are installed, templates 48 may be placed along an end of each decorative element 22.

FIG. 14 illustrates a number of decorative elements 38 placed into position and oriented using template 48. Decorative elements 38 may be staggered as shown. Templates 48 are shown in plan on the surface of element 22, and can be seen in the side view of FIG. 11. Templates 48 may be removed in the manner described above, and planks 38 installed accordingly.

FIG. 15 illustrates use of an elongate template 50. Elongate template 50 is placed in a similar manner to template 48. Template 50 is placed on the top row of elements 22 (labeled as 23 to highlight their location), and in this illustration the row consists of parts of at least four decorative elements. Template 50 permits an efficient installation of multiple or oversized decorative elements.

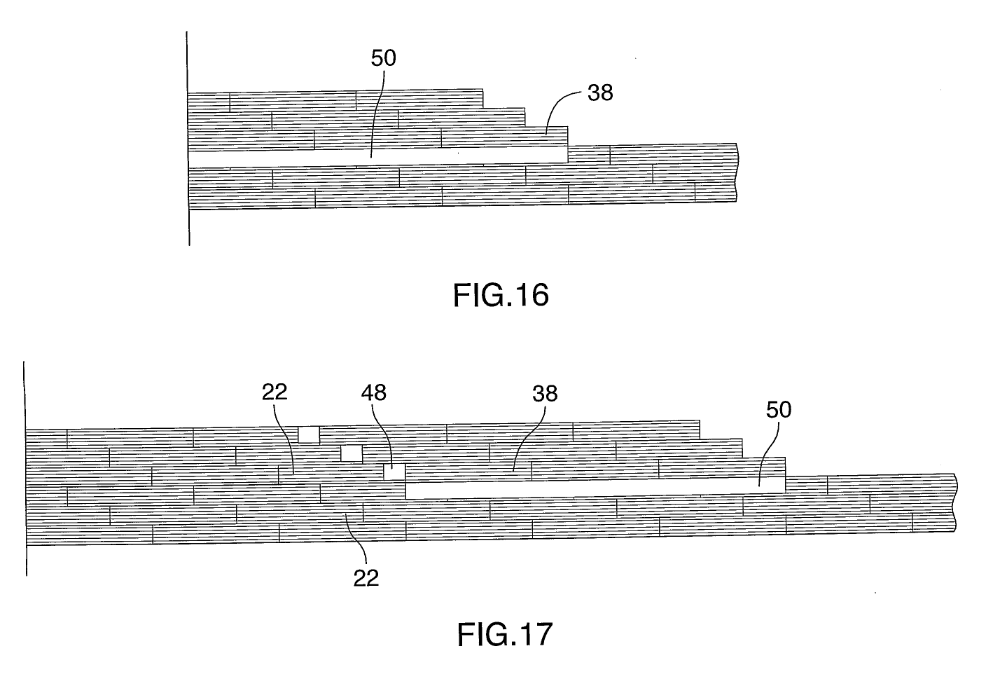

FIG. 16 illustrates additional decorative elements 38 installed and oriented by template 50. Template 50 may be removed by sliding it along decorative elements 38, or lifted, until it is free. Decorative elements 38 may be installed as described above. By installing multiple decorative elements at a time as illustrated in FIGS. 13 to 17, a desired fit is encouraged between all decorative elements, without the need to install each and every decorative element according to the method separately. Of course, it is possible to simply install each decorative covering independently according to the disclosed method.

FIG. 17 illustrates the use of templates 48 and 50 in conjunction with each other. Some decorative elements 38 will be provided with an overlap with two adjacent decorative elements 22. This encourages the reduction in play, and may cause tension, in loops 24 (and/or hooks 32) in at least two general directions. This serves to encourage other decorative coverings that have been already installed (such as the decorative coverings of FIG. 13) to be encouraged into abutting relationship to reduce the size of any gaps. This arrangement may also cause such decorative elements to become biased against one another along at least one or more of their respective edges.

As noted, FIG. 18 illustrates one or more irregularly shaped decorative elements 68 that may be installed onto a field of hooks 20 using the disclosed method.

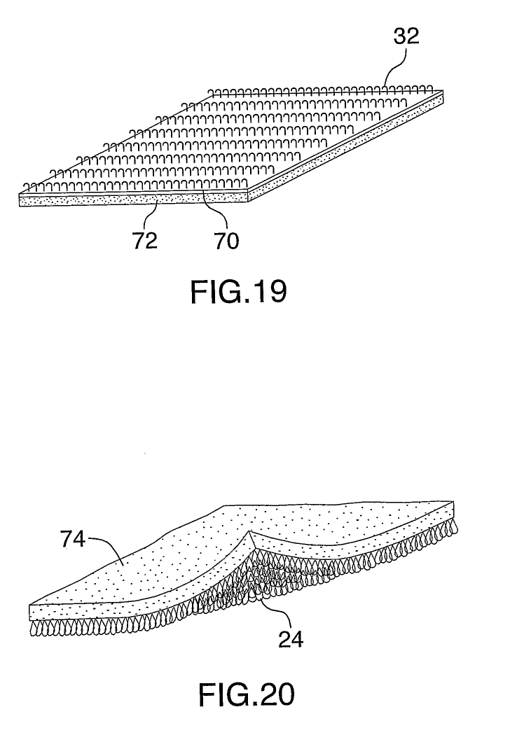

Decorative elements may also be attached to a field of hooks independently in order to form modules that may be installed to cover a surface. FIG. 19 illustrates a hook sheet 70 for receiving a decorative element. Hook sheet 70 includes hooks 32 across some or all of its surface. A resilient cushion 72 may also be included, but may also be excluded. Hook sheet 70 is somewhat flexible to permit attachment to a decorative covering in the manner described below. Loops may alternatively be provided by sheet 70 and hook may be located on decorative elements to be attached.

FIG. 20 illustrates a decorative element 74 which may be made of vinyl or other somewhat flexible material. Decorative element 74 may also include textiles such as carpet. Decorative element 74 may be provided with a surface at least partially covered with loops 24.

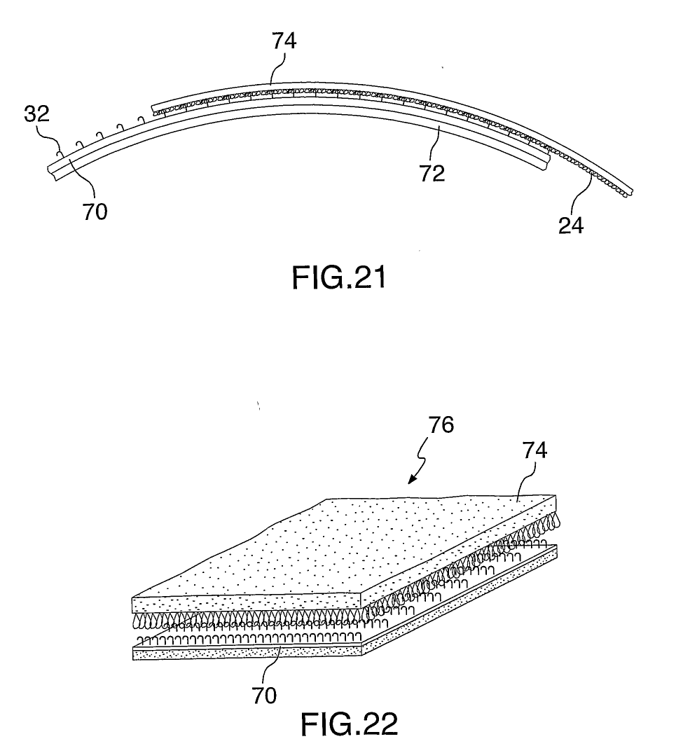

As illustrated in FIG. 21, hook sheets 70 may be bent to present a generally convex hooked surface (it may alternatively be bent to present a generally concave hooked surface). Hook sheet 70 is then maintained in a bent position, and decorative covering element 74 is placed thereon. At least some hooks 32 and loops 24 engage. (Alternatively, hook sheet 70 may be bent in some other way, such as to form a somewhat helical surface. Covering element 74 may be similarly attached.)

As shown in FIG. 22, the now combined hook sheet 70 and decorative element 74 are returned to a generally plainer configuration for placement on a surface. The bending of hook sheet 70 prior to attachment of the decorative element causes some hooks and loops to engage in the bent position. When the combined module is flattened, at least some hooks move relative to the attached loops, and any play in the loops may be reduced. This reduction in play may serve to improve the attachment between decorative element 74 and hook sheet 70 as compared to merely placing a generally planer decorative element 74 upon a hook sheet 70.

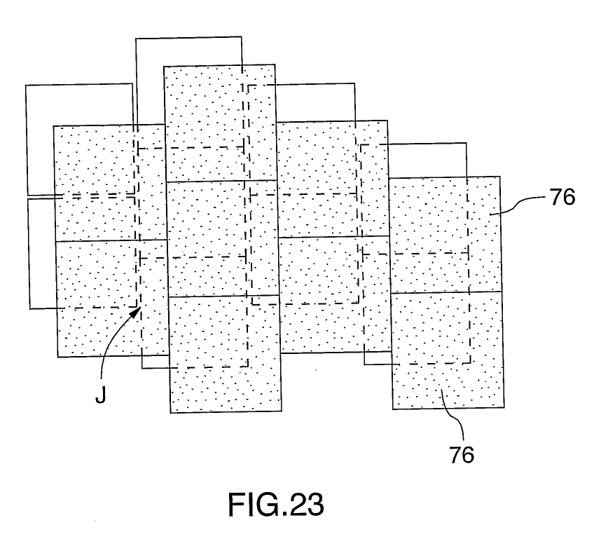

Decorative covering 74 and hook sheet 70 are preferably offset along at least one edge. This permits the combined module formed by the decorative covering and the hook sheet to be attached to like decorative coverings and hook sheets as shown in FIG. 23. Such modules 76 may be placed adjacent one another in overlapping relationship. Module 76 may also be assembled by employing the method described above by overlapping adjacent decorative elements 76. As shown in dashed lines in FIG. 23, decorative elements 74 and hook sheets 76 are oriented relative to one another so that a gap “J” is formed between installed hook sheets 70. Gap “J” may be similar in size to a preferred overlap “B”. This may facilitate the method described above to be carried out by providing room for the hook sheets 76 to move. Gap “J” also permits expansion and contraction of elements of module 76. The installation may also have little or no gap “J”.

While it is preferred that decorative element 74 is somewhat flexible. A more rigid decorative element, for example, made of wood, may be used with some benefit. When a stiff decorative element is used, bending of hook sheet 70 should be minimal to encourage at least a few hooks and loops to engage. Once hook sheet 70 is flattened, some tensioning of previously engaged hooks and loops may provide improved securement of the rigid decorative element to the hook sheet.

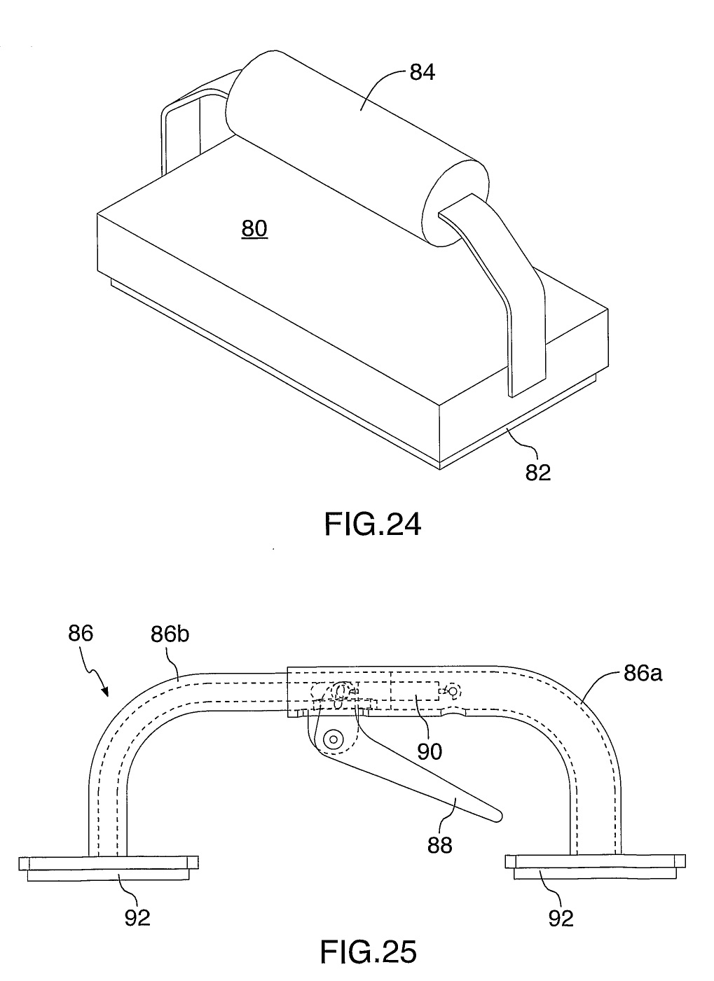

FIG. 24 illustrates one example of a blunt instrument 80 that may be used to encourage the movement of decorative element 38 relative to decorative element 22. Blunt instrument 80 is preferably made of a relatively heavy material such as a metal. Blunt instrument 80 may include a cushion 82, made of a deformable substance such as rubber so that the decorative elements are not damaged when they come into contact with blunt instrument 80. Blunt instrument 80 may also include a handle 84. Blunt instrument 80 may be used in the manner described above. For example, it may be applied generally in direction “A” by applying force to overlap “B”. Force may also be applied to some extent in direction “C” to encourage movement of decorative element 38.

FIG. 25 illustrates an alternative tool that may be used to encourage the movement of decorative element 38 relative to decorative element 22. Spreader 86 includes two grips 92, each of which is placed on the respective decorative elements 22 and 38. Grips 92 may be made of rubber or other suitable material that resists slipping or sliding on a surface of the decorative elements. Grips 92 are joined by handle portions 86a and 86b. Portions 86a and 86b slidably engage one another. Portion 86a may be provided with a spring loaded lever 88 pivotally mounted thereto. An end of lever 88 may include a spring 90 mounted thereto. The other end of spring 90 may be mounted to portion 86a. The spring end of lever 88 also engages portion 86 so that pivoting movement of lever 88 may cause grips 92 to move relative to each other. Accordingly, when lever 88 is squeezed toward portion 86a, grips 92 move apart. This causes decorative elements 38 and 22 to move relative to one another and to ultimately become co-planer, as described above. When the spreader 86 is lifted away from the decorative elements, the spring 90 causes the grips 92 to return to a position where they are closer to one another.

While the foregoing embodiments of the invention have been described in some detail for purposes of clarity and understanding, it will be appreciated by one skilled in the art, that numerous modifications, variations, and adaptations may be made to the particular embodiments of the invention described above without departing from the scope of the invention, which is defined in the following claims.

1. A method for installing a first surface covering element and a second surface covering element onto a surface, each of the elements having one half of a hook and loop attachment system, and the surface having the other of the hook and loop attachment system, the method comprising:
(i) placing the first element onto the surface so that at least some of the respective hooks and loops of the first element and surface engage;
(ii) placing the second element to marginally overlap the first element by a generally uniform amount, so that at least some of the respective hooks and loops of the second element and surface engage; and
(iii) applying a force to the second element, adjacent the overlap, to encourage the second element to move and to become generally coplanar with the first element and to eliminate the overlap.

2. The method of claim 1, further comprising in step (ii), placing the second element with an amount of overlap that causes the loops to bias the second element against the first element after step (iii).

3. The method of claim 2, wherein the amount of overlap is selected to cause the second element to be biased against the first element to create a seal between the first and second elements that is resistant to liquid transfer.

4. The method of claim 3, wherein the amount of overlap in step (ii) is determined by a measurement of the maximum extension of the possible movement between the second element and the surface when at least some of the respective hooks and loops of the second element and surface engage, and the overlap is less than or equal to such maximum extension.

5. The method of claim 3, wherein the amount of overlap in step (ii) is a function of the maximum resiliency of the loops.

6. The method of claim 3, wherein the amount of overlap in step (ii) is a function of the maximum length of the loops.

7. The method of claim 1, wherein the surface is a subfloor, and the method further comprises, before step (i), the step of placing the subfloor onto a floor, without attaching the subfloor to the floor.

8. (canceled)

9. (canceled)

10. The method of claim 1, wherein the force is applied progressively from one area of overlap to another area of overlap.

11. The method of claim 1, wherein in step (ii) the second element is placed in a staggered relationship relative to the first element.

12. The method of claim 11, further comprising the step of:
(iv) placing a third element to marginally overlap both the first and second elements along adjacent edges by generally uniform amounts, so that at least some of the respective hooks and loops of the third element and surface engage; and
(v) applying a force to the third element, adjacent the overlap, to encourage the third element to move and to become coplanar with the first and second elements and to eliminate the overlaps.

13. The method of claim 1, further comprising the step of:
(iv) repeating all previous steps for a third element in conjunction with at least one of the first and second elements.

14. The method of claim 1, wherein the first element is rigid.

15. The method of claim 1, wherein the first element is made of one of vinyl, wood, linoleum, plastic, ceramic and rigid backed carpet.

16. The method of claim 1, further comprising, after step (i), positioning a template relative to the first element to cause the second element to overlap the first element by a predetermined amount; and, after step (ii), removing the template.

17. The method of claim 1, in which the first element also moves to tension the loops.

18. A decorative floor covering installation comprising:
a first surface covering element;
a second floor covering element;
a surface for receiving the first and second elements, each of the elements having one half of a hook and loop attachment system, and the surface having the other of the hook and loop attachment system, the first and second elements being attached to the surface by the hooks and loops, and the first and second elements being biased against one another.

19. The decorative floor covering of claim 18, wherein at least some loops are approaching maximum extension and movement of at least one of the elements away from the other is limited.

20. (canceled)

21. (canceled)

22. (canceled)

23. (canceled)

24. The decorative floor covering of claim 23, wherein the predetermined amount is at least twenty-five percent of a maximum extension of the loops.

25. The decorative floor covering of claim 1, wherein the first element is flexible and resists folding.

26. (canceled)

27. A method for making a floor covering module having a covering element with at least one side substantially covered in one of hooks and loops of a hook and loop attachment system, and a sheet substantially covered the other of hooks and loops, the method comprising the steps of:
(i) bending the sheet;
(ii) placing the covering element onto the sheet to permit at least some of the hooks to engage at least some of the loops; and
(iii) flattening the combined sheet and covering element for placement onto a surface.

28. (canceled)

29. (canceled)

30. (canceled)

31. (canceled)

32. (canceled)
